(19) United States
(12) Patent Application Publication
(10) Pub. No.: US 2017/0221340 A1
(43) Pub. Date: Aug. 3, 2017

(54) BED SENSOR ALARM CLOCK SYSTEM AND DEVICE

(71) Applicant: Atlast Industries, LLC, Grand Rapids, MI (US)

(72) Inventors: Donald E. Rhoads, JR., Comstock Park, MI (US); Peter G. Wagner, Kentwood, MI (US)

(73) Assignee: Atlast Industries, L.L.C.

(21) Appl. No.: 15/417,525

(22) Filed: Jan. 27, 2017

Related U.S. Application Data
(60) Provisional application No. 62/288,871, filed on Jan. 29, 2016.

(51) Int. Cl. G08B 21/22; G08B 21/18; G08B 3/10

(52) U.S. Cl. CPC G08B 21/22; G08B 3/10; G08B 21/182

(57) ABSTRACT

An alarm clock system includes a pressure sensor disposed at or below a sleeping surface and a device configured to activate an alarm in response to a set time elapsing, such as when a clock of the system attains the set wake time. The alarm device receives a signal from the pressure sensor and deactivates the alarm when the signal from the pressure sensor indicates that the person is no longer resting on the sleeping surface, for example when the person gets out of bed. For a period after the set wake time, the device may reactivate the alarm when the sensor senses a person resting on the sleeping surface, for example when the person gets back into bed.

### CROSS REFERENCE TO RELATED APPLICATION

The present application claims the filing benefit of U.S. provisional application Ser. No. 62/288,871, filed Jan. 29, 2016, which is hereby incorporated herein by reference in its entirety.

### FIELD OF THE INVENTION

The present invention relates generally to the field of alarm clocks used to wake people.

### BACKGROUND OF THE INVENTION

As generally understood, alarm clocks are typically operated by setting a time for the device to generate sounds and/or vibrations intended to wake or otherwise alert a person to get out of bed. However, it is also known that some people have a tendency to turn off the alarm and fall back asleep, thereby rendering the alarm ineffective. In attempt to avoid this ineffectiveness, a “snooze” function is commonly provided on alarm clocks to temporarily inactivate the alarm for a period of time and allow the person to resume sleeping or postpone getting out of bed until the “snooze” time elapses and the alarm sounds again. This “snooze” function can be abused with repeated actuations or altogether ignored by turning off the alarm clock. Also, to avoid the tendency of going back to sleep after turning off an alarm clock, it is known for alarm clocks to be located a sufficient distance away from a bed to require the person to physically get out of bed in order to deactivate the alarm. In addition to the spaced location potentially being inconvenient at times when the alarm is not use, such as when the alarm clock is referenced as a clock, the spaced location does not necessarily prevent people from returning to the bed after the alarm is deactivated, may cause people to forget to set the alarm, and may also increase the tendency for the alarm to disturb other people near the alarm location.

### SUMMARY OF THE INVENTION

The present invention provides an alarm clock system for waking or alerting a person resting on a sleeping surface, such as a bed or cot or the like, where the system incorporates sensors, such as weight or pressure sensors at or below the sleeping surface, for controlling the alarm in response to movements of the person onto or off of the sleeping surface. The system also provides a device that activates an alarm in response to a set time, such as when a clock of the system attains the set wake time. In such a system, the device receives a signal from the sensor and deactivates the alarm when the signal from the sensor indicates that the person is no longer resting on the sleeping surface, for example when the person gets out of bed. Optionally, for a period after the set wake time, the device may reactivate the alarm when the sensor senses a person resting on the sleeping surface, for example when the person gets back into bed

In accordance with one aspect of the present invention, an alarm clock system is provided with a weight sensor and an alarm device for waking and encouraging a person to get out of a bed. The weight sensor is configured to be disposed at or below a sleeping surface of the bed. The alarm device is electrically connected to the weight sensor and configured to be disposed at a side area of the bed. The alarm device is operable to activate an alarm in response to a set time occurring and operable to deactivate the alarm in response to receiving a signal from the weight sensor indicating that a select person is not resting on the sleeping surface. Optionally, the alarm device may reactivate the alarm in response to receiving a signal from the weight sensor indicating that the select person has resumed resting on the sleeping surface, such as for a selected period after the alarm is deactivated.

In accordance with another aspect of the present invention, an alarm clock system for waking and encouraging a person to get out of a bed provides a pressure sensor that is configured to be disposed between a mattress and a mattress support, where the pressure sensor is operable to sense the weight of a person resting on a sleeping surface of the mattress. An alarm device includes a speaker and a controller that is operable to actuate the speaker to generate a first audible alarm at a preset time of day. The alarm device is operable to continue to generate the first audible alarm until a signal received from the pressure sensor indicates that the weight of the person is no longer present on the sleeping surface. The alarm device may, optionally, be configured to generate a second audible alarm in response to receiving a signal from the weight sensor indicating that the weight of the person is again resting on the sleeping surface, thereby deterring the person from returning to the bed.

In accordance with yet another aspect of the present invention, a method is provided for waking and encouraging a person to get out of a bed. The method includes positioning a weight sensor at or below a sleeping surface of the bed in a location arranged to sense a select person resting on the sleeping surface, and positioning an alarm device that is electrically connected to the weight sensor at a side area of the bed. An alarm is activated with the alarm device in response to a set time occurring. The alarm is deactivated in response to the alarm device receiving a signal from the weight sensor indicating that the select person is not resting on the sleeping surface. In such a method, the alarm device may reactivate the alarm in response to receiving a signal from the weight sensor indicating that the select person has resumed resting on the sleeping surface.

These and other objects, advantages, purposes and features of the present invention will become apparent upon review of the following specification in conjunction with the drawings.

### BRIEF DESCRIPTION OF THE DRAWINGS

FIG. 1 is an upper perspective view of an alarm clock system having an alarm device and a weight sensor arranged between a mattress and a mattress support surface, in accordance with the present invention;

FIG. 2 is a cross-sectional side elevational view of the alarm clock system of FIG. 1 having a box spring forming the mattress support surface;

FIG. 2A is a cross-sectional side elevational view of the alarm clock system of FIG. 1, showing the alarm device flipped to be arranged at a mattress platform forming the mattress support surface;

FIG. 3 is a top plan view of the alarm clock system of FIG. 1 having the weight sensor arranged on a bed;

FIG. 4 is an upper perspective view of the alarm device of the alarm clock system shown in FIG. 1;

FIG. 5 is an upper perspective view of the weight sensor of the alarm clock system shown in FIG. 1;

FIG. 6 is a cross-sectional view of an additional embodiment of the alarm clock system having an alarm device and multiple sensors arranged between a mattress and a box spring;

FIG. 6A is an enlarged view of a section of FIG. 6, showing the alarm device having a portion pivoted outward from the mattress;

FIG. 7 is a top plan view of an additional alarm clock system having two weight sensors arranged on a bed;

FIG. 8 is a top plan view of an additional alarm clock system having three sensors arranged on a larger bed than that shown in FIG. 7;

FIG. 9 is a top plan view of an additional arrangement of two separate alarm clock system defining two sleeping zones on a single bed;

FIG. 10 is an front elevational view of an additional alarm device of an alarm clock system, in accordance with the present invention;

FIG. 11 is a rear elevational view of the alarm device shown in FIG. 10;

FIG. 12 is a side elevational view of the alarm device shown in FIG. 10;

FIG. 13 is a cross-sectional top view of the alarm device shown in FIG. 10, illustrating an interior of the alarm device;

FIG. 14 is a cross-sectional elevational view of the alarm device shown in FIG. 10, illustrating a rear wall of the alarm device;

FIG. 15 is a schematic control diagram for operating an alarm clock system in accordance with the present invention;

FIG. 16 is a flow chart of a setup and calibration routine for operating the alarm clock system in accordance with the present invention; and

FIG. 17 is a flow chart of an operational routine for operating the alarm clock system in accordance with the present invention.

### DESCRIPTION OF THE PREFERRED EMBODIMENTS

Referring now to the drawings and the illustrative embodiments depicted therein, an alarm clock system 10 includes a weight or pressure sensor 12 that is disposed at or below a sleeping surface 14 and an alarm device 16 that configured to activate an alarm for waking a person. The device 16 is capable of receiving a signal from the sensor 12 that is indicative of whether the person is resting on the sleeping surface 14. The alarm device 16 may then control the activation of the alarm in response to the signal from the sensor 12, such as to deter a person from staying in bed or getting back into bed after the alarm is activated. For example, the alarm device 16 may initially activate the alarm at a preset wake time and then only deactivate the alarm when the sensor 12 senses that the person gets out of bed or otherwise off of the sleeping surface 14. Also, after the alarm is initially activated, the alarm device 16 may reactivate the alarm when the sensor 12 senses that the person has resumed resting on the sleeping surface 14 or otherwise gotten back into bed. It is contemplated that the alarm clock system 10 may be configured for different types of sleeping surfaces, such as beds, cots, couches, reclined chairs, or the like, and may also be configured for different zones of a sleeping surface, such as for a bed that is usually occupied by two or more people or pets. Also, the activated alarm may generate various types of alerts, such as with a speaker, a vibration motor, and a light source or the like for waking or altering a person.

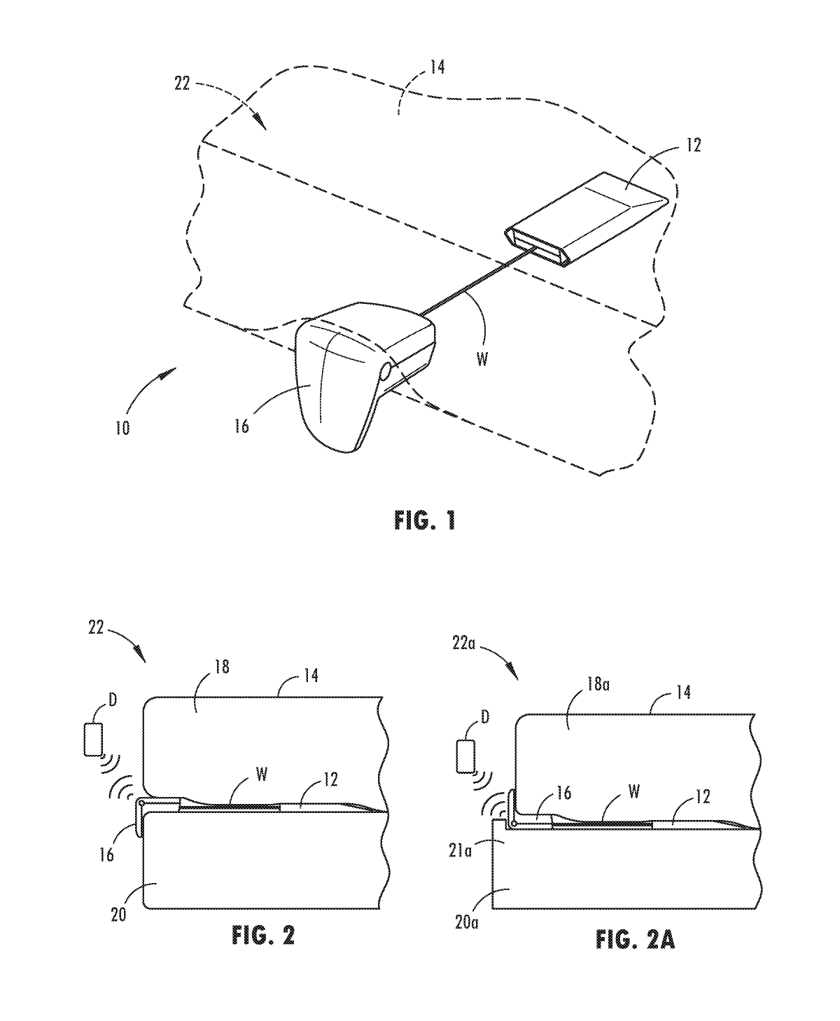

The illustrated alarm clock system 10, such as shown in FIG. 1, provides a single weight or pressure sensor 12 that communicates with the alarm device 16 via a wired connection W configured to be disposed at least partially below the sleeping surface. The sensor 12 may comprise various types of sensors, such as a pressure sensor, a touch sensor, a motion sensor, a heat sensor, a microphone, an optical sensor, a capacitive sensor, an ultrasonic sensor, or other conceivable types of sensors that may be used to sense the presence or occupancy of a person on or near a sleeping surface. The illustrated weight sensor 12, such as shown in FIG. 5, includes a substantially flat sensor module that includes at least one pressure-sensitive resistor that is configured to be arranged between an upper cushion or mattress 18 and a mattress support 20 or base support of a bed 22, which is shown in FIG. 2 as a box spring 20 supporting the mattress 18. Alternatively, such as show in FIG. 2A, the weight sensor 12 is arranged between a mattress 18a and a mattress platform 20a that supports the mattress 18a of the bed 22a and that has an edge portion 21a that prevents the alarm device 16 from being oriented as shown in FIG. 2. Accordingly, the alarm device 16 is configured to be flipped vertically to be oriented with a nose portion protruding upward, as shown in FIG. 2A to accommodate the mattress platform 20a. As understood, the upper surface of the mattress 18 defines the sleeping surface 14 in this embodiment. It is also contemplated that the sensor 12 may be otherwise disposed closer to the upper surface, such as between a bed sheet and the mattress 18, or at a lower position, such as between the box spring 20 and the floor or ground surface. It is also conceivable that the sensors 12 may be incorporated into or as part of the mattress 18, the box spring 20, and/or other components or portions of the bed.

The alarm clock system 10, as shown for example in FIGS. 1-5, provides the alarm device 16 with the capability of wirelessly communicating with a mobile computing device D that wirelessly communicates with a transceiver that is integrated with the alarm device 16 and provided within the housing 24. The wireless connectivity may be done for example via Bluetooth or the like. The mobile device D, such as a smart phone or tablet, may then provide a clock time, a set alarm time, alarm sound settings, and other programmable alarm settings, such as from an application operating on the mobile device D. The alarm device 16 may also include a light indicator that provides an indication, such as the battery status, the alarm system being activated (on) or deactivated (off), and when the alarm system is on, that the alarm is activated (generating alerting sounds). It is also conceivable that the alarm device 16 may have a user input, such as a button, to perform various inputs, such as to calibrate the weight. Although possible, any user input on the alarm device is preferably not capable of deactivating the alarm. Also, it is preferred that the mobile device is not used to generate or deactivate the alarm, as such an arrangement would allow for relatively easy deactivation or avoidance of the alarm without necessarily requiring the user to get out of the bed. In other wireless embodiments, a transceiver may alternatively be integrated with each sensor 12.

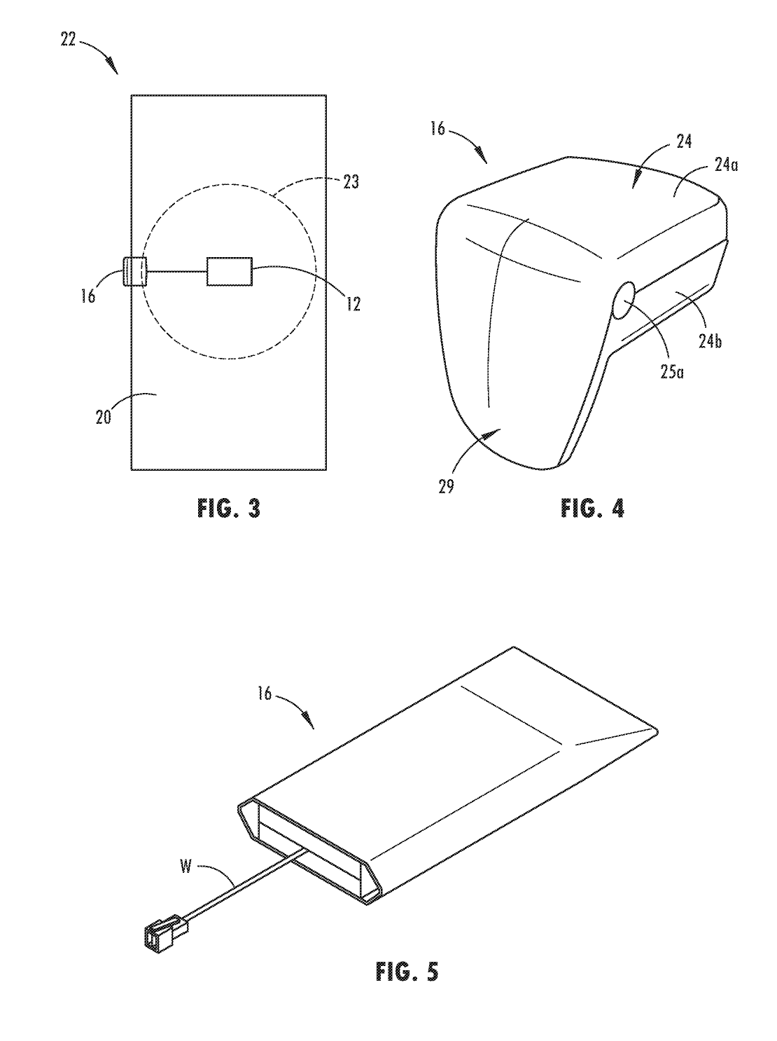

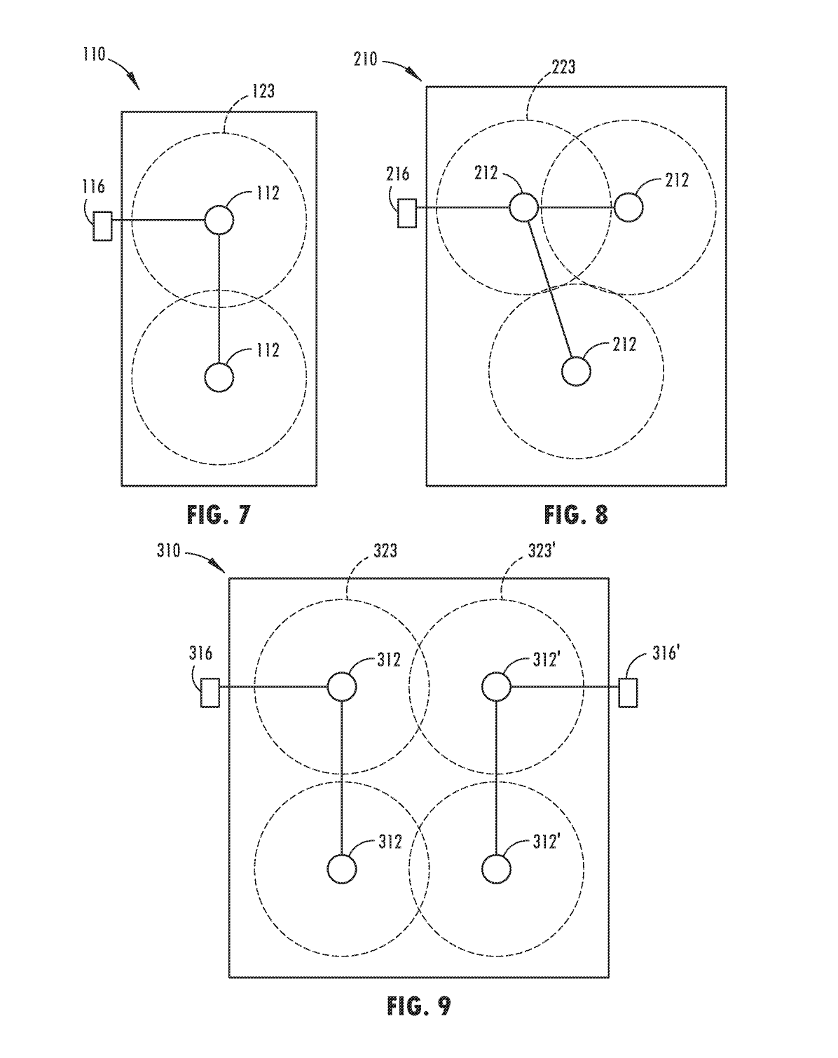

As shown in FIG. 3, the illustrated pressure sensor 12 is arranged at a generally central location at or below the sleeping surface to sense the presence and weight of a person on the sleeping surface. The sensor 12 may be arranged in different positions depending on the user's bed size and sleeping situation, such as shown in FIGS. 7-9 and described further herein. Further, FIG. 3 illustrates the weight sensor 12 being centrally located between the head and foot portion of the bed 22, to provide a sensory area 23 that generally senses the person when resting at various different locations of the bed and thus the sensor is positioned to prevent the person from relocating to a different location on the sleeping surface to deactivate the alarm. The sensory area 23 generally defines the boundary or area within which the sensor 12 is able to accurately detect a person's presence, such as a downward force that correlates with the average weight or a threshold weight for a person. The illustrated sensory area 23 is exemplary and may be conceivably be expanded to cover the entire bed, such as by adjusting the sensitivity of the sensor 12. Also, it is contemplated that additional sensors may be connected to the sensor 12, such as via a wire in a daisy chain configuration, to expand the sensory area 23 of the system 10. As described herein, the sensor 12 and/or alarm device 16 of the alarm clock system 10 may be calibrated with a weight or weight range of a person and may be customizable by a user, for instance to prevent the weight of a child or pet or small object from activating or deactivating the alarm. It is also understood that the sensory area 23 may also be customized or altered with the system or with different types of sensors.

An embodiment of the alarm device 16 is shown in FIG. 4 and includes a housing 24 that contains components of the device 16. The housing 24 has an upper portion 24a and a lower portion 24b that attach together to enclose the components. The housing also provides a speaker port 25a that directs the sound generated by a speaker 25 contained within the housing 24 to easily be emitted from the housing 24. The nose portion 29 of the housing 24 is angled generally perpendicularly from the base portion of the housing 24 that is disposed between the mattress and the mattress support (FIGS. 2 and 2A), such that the nose portion 29 maintains the position of the alarm device 16 at the side area of the bed, thereby preventing the alarm device 16 from being located entirely beneath the mattress. The illustrated housing 24 is a substantially rigid containment structure, which may preferably be comprised of a plastic material, such as formed via injection molding, but may also be made of glass or metal or a composite material. The housing 24 is also configured with the upper and lower portions 24a, 24b securely attached to each other, such as via metal fasteners (screws or bolts), to prevent the user from removing the power source that assists to generate the alarm in an effort to easily disable the alarm and remain in bed.

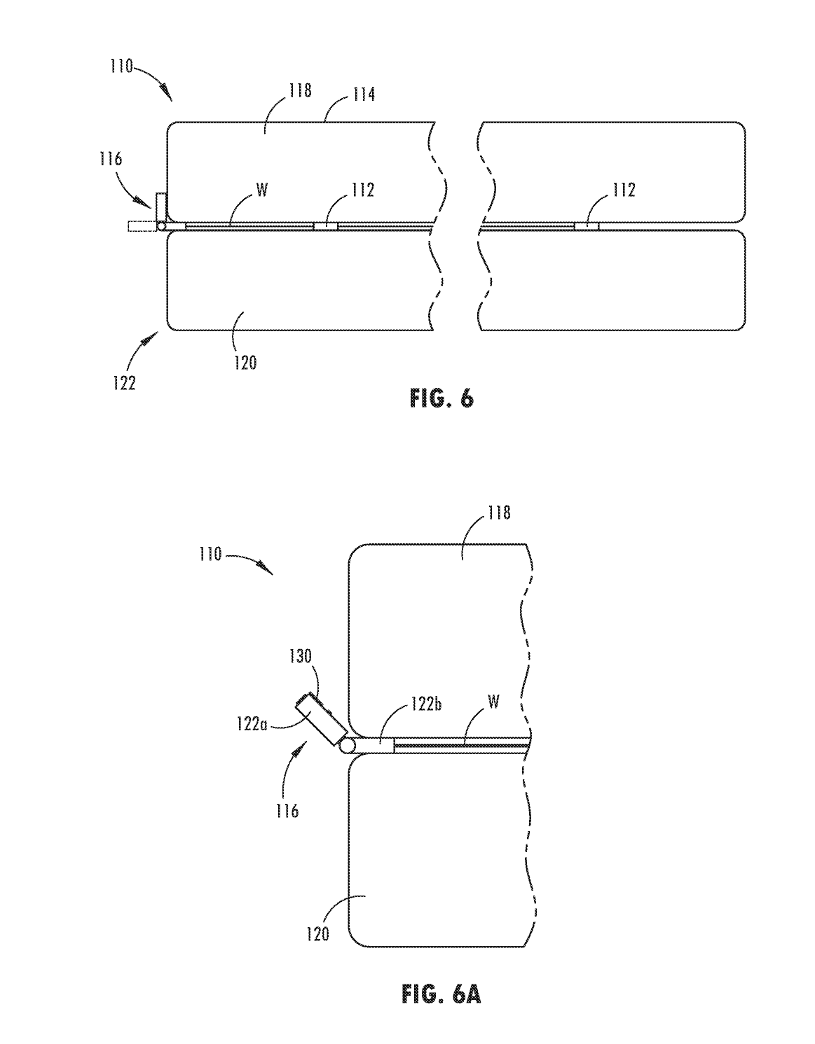

An additional embodiment of the alarm clock system 110 is shown in in FIGS. 6-6A, which provides at least two sensors 112 that are arranged between a mattress 118 and a box spring 120 or base support of a bed 122. As understood, the upper surface of the mattress 118 defines the sleeping surface 114 in this embodiment. Accordingly, it is again contemplated that the sensors 112 may be otherwise disposed closer to the upper surface, such as between a bed sheet and the mattress 118, or at a lower position, such as between the box spring 120 and the floor or ground surface. The alarm device 116 includes a housing 122 that includes an outer portion 122a that is pivotably coupled with an inner support portion 122b of the housing that is disposed between the mattress 118 and box spring 120 and is electrically connected to the sensors 112 via a wire W. The outer portion 122a of the housing 122 protrudes from the seam between the mattress and box spring, and is thereby arranged to pivot about the pivotable connection at least between a substantially vertical orientation and a generally horizontal orientation, as shown in FIG. 6. The vertical orientation of the housing 122 may conceal the display screen 130 against the side surface of the mattress 118, such that the alarm device 116 can assume a concealed or un-obstructing position, and similarly the outer portion 122a of the housing 122 may be pivoted away from the mattress toward the horizontal orientation to assume a deployed or usage position for the user to view or otherwise interact with the alarm device 116, such as by making inputs at the button 128 and viewing the outputs at the display screen 130, for example to set the wake time, calibrate the weight, or provide other alarm settings.

As shown in FIGS. 7-9, the illustrated pressure sensors 112 are dispersed at spaced locations at or below the sleeping surface to sense the presence of a person on the sleeping surface. The sensors 112 may be arranged in an array of different positions depending on the user's bed size and sleeping situation. Specifically, FIG. 7 illustrates a sensor 112 near the head portion of the bed and another sensor 11 near the foot portion of the bed, which prevents a person from relocating to a different location on the sleeping surface to deactivate the alarm. Similarly, FIG. 8 illustrates three sensors 212 spaced relative to the sleeping surface to accommodate a large sized bed from that shown in FIG. 3. Further, as shown in FIG. 9, the alarm clock system 310 is adapted for two people that sleep on the same bed or sleeping surface. The illustrated system 310 includes two separate devices 316 and 316′ that each connect to two sensors 312 and 312′, which are arranged at spaced locations on the sleeping surface. The sensors 312 and 312′ are arranged to define two separate zones of the sleeping surface for each person, the illustrated zones being defined by the sensory areas 323 associated with each device. In such a system, the devices may be independently operated or may be operated together, including allowing the devices to communicate with each other, such as for example allowing one of the devices to recognize if the person simply moves to the other side of the bed, instead of getting out of bed. Each pressure sensor 112, 212, 312 has a sensory area 123, 223, 323 that generally defines the boundary within which the sensor 112, 212, 312 is able to accurately detect a person's presence, such as a downward force that correlates with the average weight or a threshold weight for a person. It is understood that the sensory area 123, 223, 323 may also be customized or altered with the system or with different types of sensors

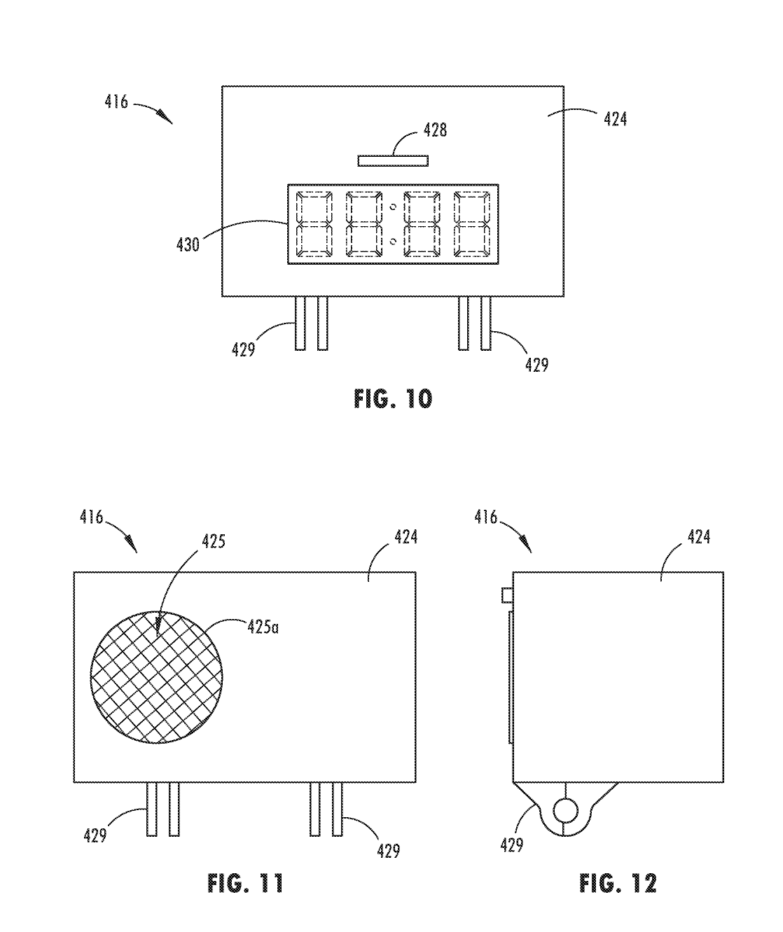

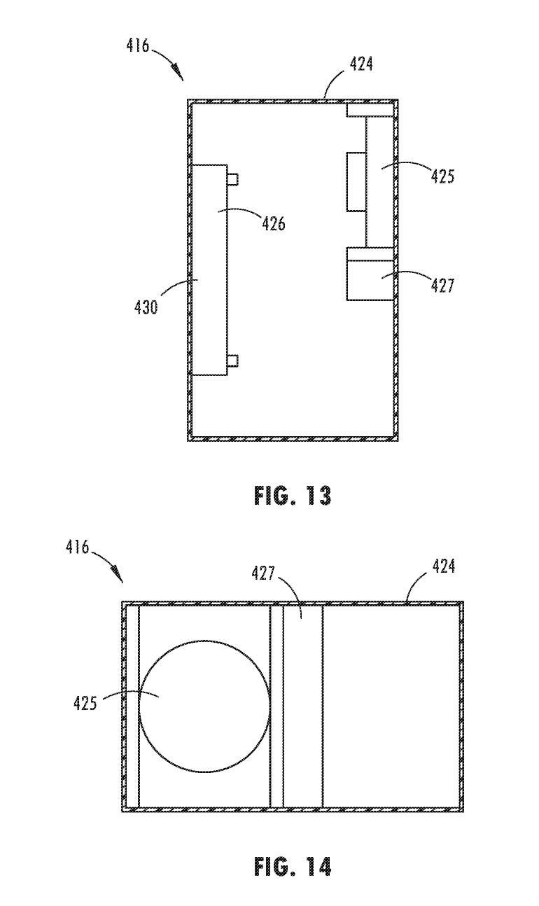

Another exemplary embodiment of the alarm device 416 is shown in FIGS. 10-14, illustrating a housing 424 that contains components of the alarm device 416. The housing 424 is provided with pivot connectors 429 that protrude from a lower portion of the housing 424 to pivotally connect with a support member that is configured to be held and disposed between a mattress and a mattress support surface, such that the components of the alarm device can be electrically connected to the sensors via a wire. As shown in FIGS. 10 and 13, the illustrated components of the alarm device 416 include a speaker 425, a printed circuit board with a micro controller 426, a battery 427, a button or switch 428, and a display 430. The illustrated display 430 (FIG. 10) may be a 7-segment display to display the time and/or set alarm time. The illustrated housing 422 is a substantially rigid containment structure and may also be provided with an access door to conceal the battery compartment, which is securely attached to the housing, such as via metal fasteners (screws or bolts), to prevent the user from removing the power source that assists to generate the alarm in an effort to easily disable the alarm and remain in bed. Accordingly, the settings to disable the alarm from the device may be configured to require the sensors to be unobstructed or the cover and fasteners to be removed, in an effort to similarly prevent the alarm form being easily disable.

An exemplary illustration of a schematic control diagram for these components of the alarm clock system 10 is provided in FIG. 11. As shown, the mobile device D has a user interface for providing user inputs and alarm settings to the controller 26 of the alarm device 16 and may also communicate back to the user, such as with its own display screen, sounds, lights, or the like. The mobile device D may, for example, be used to modify the alarm settings 38 that are stored in a memory unit of the controller 26. The alarm settings 38 may include the set wake time that operates to actuate the alarm; a day setting associated with the wake time, such as weekdays; an alert preference, such as a certain chime, sound, song, light pattern, vibration, or the like; a setting for the period of time that the system will monitor the sensors 12 after the alarm is deactivated; and other settings associated with the operational functions of the alarm clock system 10. The associated alarm settings may also be based on the connected alarm hardware, which may include a speaker, a vibration motor, a light source, and/or the like.

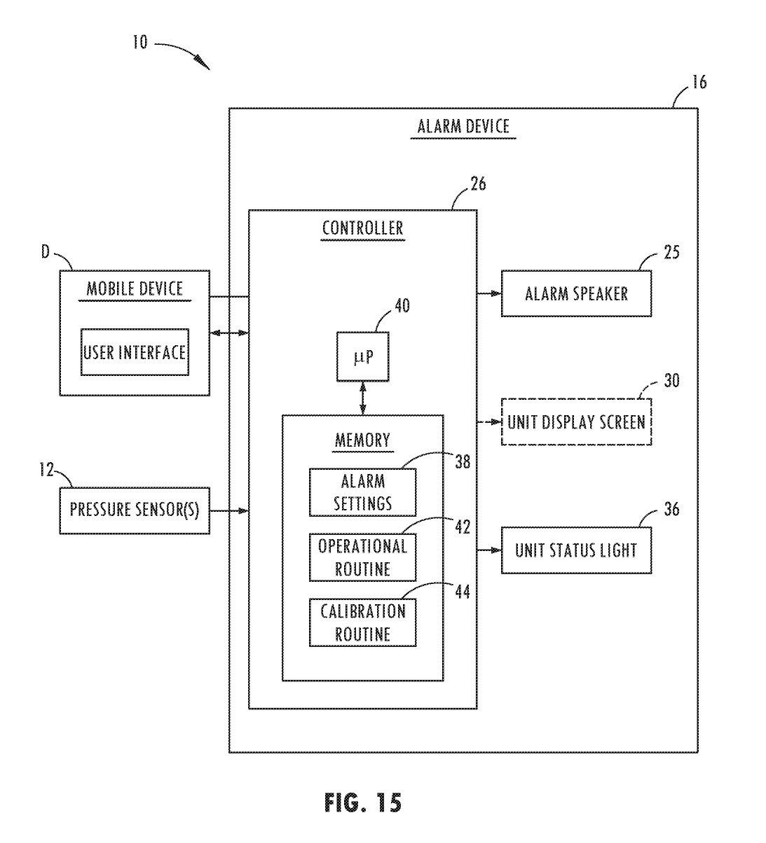

With respect to the calibration and operational control of the alarm clock system 10, the controller 26 may be configured to operate the sensor(s) and device for one or multiple users, such as for one or more zones on a sleeping surface. The controller 26 of the alarm clock system 10 may include a microprocessor 40 and/or other analog and/or digital circuitry for processing one or more routines or algorithms to operate the alarm clock system 10 as desired. Additionally, the controller 26 may include memory for storing one or more routines or algorithms, including alarm settings 38, an operational routine 42, and a calibration routine 44. It should be appreciated that the controller may be a standalone dedicated controller, multiple separate controllers, or may be a shared controller integrated with other control functions, such as integrated with the user interface device, such as a wireless device or mobile computing device, to process the user and sensor inputs and perform related functionality. The exemplary control schematic shown in FIG. 15 receives inputs from the pressure sensors 12 and operates the alarm clock system 10 as desired.

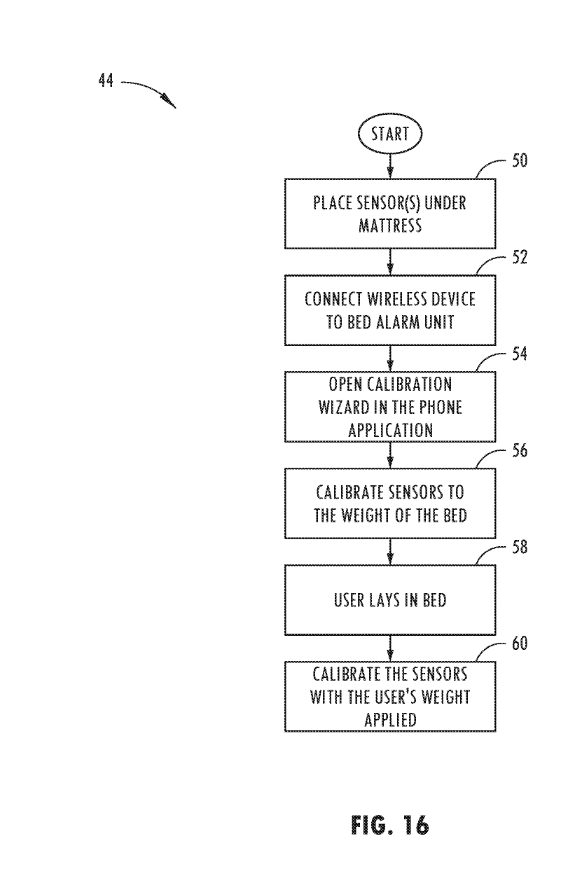

Prior to operating the operational routine 42, the controller 26 may perform the calibration routine 44, such as by prompting the user on the mobile device D. Accordingly, it is also contemplated that the calibration routine 44 may be stored and processed on the mobile device D, and the resulting settings may be output to the controller 26 of the alarm device 16 for storage in the memory. As shown in FIG. 16. At step 50, the calibration routine 44 first prompts the user to place the sensor(s) 12 under the mattress at a location that allows the alarm device 12 to be placed at the side area of the bed, such as shown in FIG. 1, and for the sensors to correspond to the user's bed size and/or sleeping situation. The user is then prompted at step 52 to connect the wireless device to the alarm device 16, such as with a Bluetooth connection. At step 54, the calibration wizard may be opened on the mobile device, if it is not already running on the mobile device D. At step 56, the alarm device is then calibrated to the weight of the bed being empty, such as without the user resting on the bed, although blankets and pillows may remain on the bed at this time. To do so, the sensors 12 provide a signal or weight output when the user indicates that the bed is empty by providing an input, such as at the user interface of the mobile device. The user, at step 58, is then prompted to lay in the bed in a typical sleeping position, such that the alarm device can be calibrated for the user's weight, where the sensors 12 provide a signal or weight output when the user indicates that the user is occupying the bed by providing an input, such as at the user interface of the mobile device. With the weight of the bed and the weight of the user in the bed, the controller (or mobile device) can determine a weight range for the select person resting on the sleeping surface, which is stored in the alarm settings 38 for use by the operational routine 42. Thus, weight that is present in the bed, such as from another person or animal or the like, will not affect the alarm determinations if such weight is calibrated for when the user's weight is recorded.

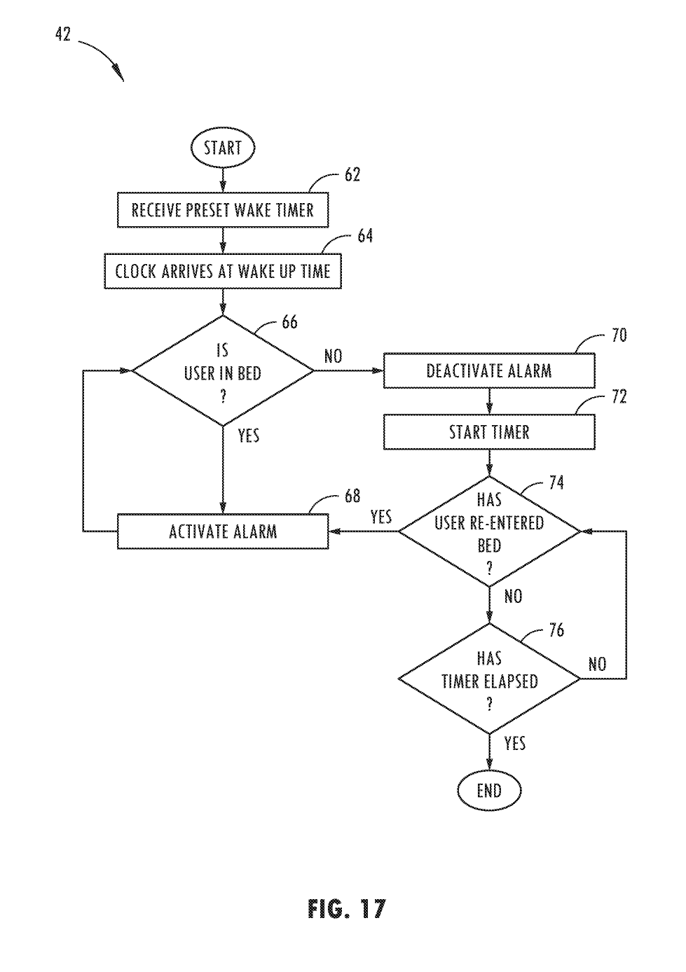

As illustrated in FIG. 17, the operational routine 42 may start by the controller 26 receiving the preset wake time, such as from a user or from the stored alarm settings. The set time input may identify a specific time and day for the alarm to actuate or generate the desired alert. Based on the input from the user, at step 64, the controller can operate to activate the alarm or generate an alert, such as with the speaker, in response to the clock of the device arriving at the preset time, which may be done by accessing the alarm settings 38 and comparing it with a clock or timer, such as a clock set on the device. At step 66, the routine performs a determination as to whether the user is in bed, such as by determining that the select person is resting or not resting on the sleeping surface when a sensed weight from the weight sensor is, respectively, within or outside the weight range, such as provided by the calibration routine. If it is determined that the user is in bed at the set time, the alarm is actuated at step 68. The routine then returns to step 66 to determine whether the person is in bed, and thus the alarm is not deactivated until it is determined that the person is out of bed, at step 70. Once the alarm has been deactivated, a timer may started at step 72, such that a preset period of time must elapse before the system is completely deactivated. During the period of time, at steps 74 and 76, the sensors are monitored to determine if the person has re-entered the bed, where such determination is substantially the same as step 66. If the person re-enters the bed, the alarm actuates at step 68, which then requires the person to get out of bed again for the alarm to deactivate.

In an additional operational embodiment, the controller may activate an alarm with a device in response to a set time being elapsed, and allow the alarm to be deactivated the alarm in response to at least one of the person leaving the sleeping surface and an input being made at the device, such as with the switch or button. In this embodiment, the alarm may also reactivate, such as after a short period of time, if the pressure sensor senses that the person is still resting on the sleeping surface.

Changes and modifications in the specifically-described embodiments may be carried out without departing from the principles of the present invention, which is intended to be limited only by the scope of the appended claims as interpreted according to the principles of patent law including the doctrine of equivalents.

1. An alarm clock system for waking and encouraging a person to get out of a bed, said alarm clock system comprising:
a weight sensor configured to be disposed at or below a sleeping surface of the bed;
an alarm device electrically connected to the weight sensor and configured to be disposed at a side area of the bed;
wherein the alarm device is operable to activate an alarm in response to a set time occurring; and
wherein the alarm device is operable to deactivate the alarm in response to receiving a signal from the weight sensor indicating that a select person is not resting on the sleeping surface.

2. The alarm clock system of claim 1, wherein, for a selected period after the alarm is deactivated, the alarm device is operable to reactivate the alarm in response to receiving a signal from the weight sensor indicating that the select person has resumed resting on the sleeping surface.

3. The alarm clock system of claim 2, wherein the alarm device is operable to receive and store the set time from a mobile computing device that is in wireless communication with the alarm device operable to generate the alarm.

4. The alarm clock system of claim 2, wherein the alarm device includes a controller operable to perform a calibration routine for determining a weight range for the select person resting on the sleeping surface, and wherein, when activating, deactivating, and reactivating the alarm, the alarm device determines that the select person is resting or not resting on the sleeping surface when a sensed weight from the weight sensor is, respectively, within or outside the determined weight range.

5. The alarm clock system of claim 2, wherein the weight sensor communicates with the alarm device via a wired connection configured to be disposed at least partially below the sleeping surface.

6. The alarm clock system of claim 2, wherein the alarm activated by the alarm device comprises a noise generated by a speaker of the alarm device at a frequency and volume for alerting the select person resting on the sleeping surface.

7. The alarm clock system of claim 2, wherein the alarm device comprises a speaker for generating the alarm and a controller for actuating the alarm based on the set time and the signal received from the weight sensor.

8. An alarm clock system for waking and encouraging a person to get out of a bed, said alarm clock system comprising:
a pressure sensor configured to be disposed between a mattress and a mattress support, wherein the pressure sensor is operable to sense a weight of a person resting on a sleeping surface of the mattress;
an alarm device having a speaker and a controller operable to actuate the speaker to generate a first audible alarm at a preset time of day; and
wherein the alarm device is operable to continue to generate the first audible alarm until a signal received from the pressure sensor indicates that the weight of the person is no longer present on the sleeping surface.

9. The alarm clock system of claim 8, wherein the alarm device is configured to be disposed at or near an edge area of the mattress.

10. The alarm clock system of claim 8, wherein the alarm device is operable to generate a second audible alarm in response to receiving a signal from the weight sensor indicating that the weight of the person is again resting on the sleeping surface, thereby deterring the person from returning to the bed.

11. The alarm clock system of claim 10, wherein, for a selected period after the first audible alarm is deactivated, the alarm device is operable to generate the second audible alarm.

12. The alarm clock system of claim 8, wherein the pressure sensor is connected to the alarm device via a wired connection.

13. The alarm clock system of claim 8, wherein the alarm device is operable to receive and store the preset time of day from a mobile computing device that is in wireless communication with the alarm device.

14. The alarm clock system of claim 8, wherein the controller of the alarm device is operable to perform a calibration routine for determining a weight range for the person resting on the sleeping surface.

15. The alarm clock system of claim 14, wherein, when generating at least one of the first and second audible alarms, the alarm device determines whether the weight of the person is present on the sleeping surface in response to a sensed weight from the pressure sensor relative to the determined weight range.

16. A method for waking and encouraging a person to get out of a bed, said method comprising:
positioning a weight sensor at or below a sleeping surface of the bed in a location arranged to sense a select person resting on the sleeping surface;
positioning an alarm device that is electrically connected to the weight sensor at a side area of the bed;
activating an alarm with the alarm device in response to a set time occurring; and
deactivating the alarm in response to receiving a signal from the weight sensor indicating that the select person is not resting on the sleeping surface.

17. The method of claim 16, wherein, after the alarm is deactivated, the alarm device is operable to reactivate the alarm in response to receiving a signal from the weight sensor indicating that the select person has resumed resting on the sleeping surface.

18. The method of claim 17, wherein the alarm device includes a controller operable to perform a calibration routine for determining a weight range for the select person resting on the sleeping surface, and wherein, when activating, deactivating, and reactivating the alarm, the alarm device determines that the select person is resting or not resting on the sleeping surface when a sensed weight from the weight sensor is, respectively, within or outside the determined weight range.

19. The method of claim 16, wherein the activated alarm generates an alert with at least one of a speaker, a vibration motor, and a light source for alerting the person resting on the sleeping surface.

20. The method of claim 16, wherein the alarm device is operable to receive and store the set time from a mobile computing device that is in wireless communication with the alarm device.
